(19) United States
(12) Patent Application Publication
(10) Pub. No.: US 2022/0138461 A1
(43) Pub. Date: May 5, 2022

(54) STORAGE MEDIUM, VECTORIZATION METHOD, AND INFORMATION PROCESSING APPARATUS

(71) Applicant: FUJITSU LIMITED, Kawasaki-shi (JP)

(72) Inventors: Jun LIANG, Kawasaki (JP); Hajime MORITA, Kawasaki (JP)

(73) Assignee: FUJITSU LIMITED, Kawasaki-shi (JP)

(21) Appl. No.: 17/493,840

(22) Filed: Oct. 5, 2021

(30) Foreign Application Priority Data
Nov. 2, 2020 (JP) 2020-183753

(51) Int. Cl. G06K 9/00; G06K 9/62; G06N 3/04

(52) U.S. Cl. CPC G06K 9/00463; G06N 3/0454; G06K 9/6261

(57) ABSTRACT

A non-transitory computer-readable storage medium storing a vectorization program that causes at least one computer to execute a process, the process includes: receiving a document; and based on information in which words and vectors are associated with each other, when a certain word that is not included in the information is detected from the document, generating a vector corresponding to the certain word by inputting a vector corresponding to each of letters included in the certain word into a machine learning model generated by machine learning based on a first vector associated with a first word included in the information and a vector corresponding to each of letters included in the first word.

### CROSS-REFERENCE TO RELATED APPLICATION

This application is based upon and claims the benefit of priority of the prior Japanese Patent Application No. 2020-183753, filed on Nov. 2, 2020, the entire contents of which are incorporated herein by reference.

### FIELD

The embodiments discussed herein are related to a vectorization technique using a machine learning model.

### BACKGROUND

In the field of natural language processing, a machine learning model for understanding contexts and generating vector representations (embedded representations) of words is used. For example, a word embedding model is used to generate a vector representation (word embedding: hereafter referred to as “emb” in some cases) of each of words appearing in sentences. Subsequently, a vector representation having understood the context from the vector representation of each word (contextualized word embedding: hereinafter referred to as “cemb” in some cases) is generated using a contextualized word embedding model.

The contextualized word embedding model for generating “cemb” is able to generate “cemb” for each word in a sentence even when an unknown word that is not included in training data at the time of machine learning appears in the sentence to be processed. For example, replacing each of the unknown words with “_UMK_” when being input to the contextualized word embedding model makes it possible to generate and input “emb” for each word, which allows “cemb” of each word to be generated.

Japanese National Publication of International Patent Application No. 2017-509963, Japanese Laid-open Patent Publication No. 2016-110284, Japanese Laid-open Patent Publication No. 2019-153098, and Japanese National Publication of International Patent Application No. 2019-536135 are disclosed as related art.

A vectorization program in a first aspect for causing a computer to execute a process, the process including: receiving a document; and in a case that, based on information in which words and vectors are associated with each other, a specific word that is not included in the information is detected from the document, generating a vector corresponding to the specific word by inputting a vector corresponding to each of letters included in the specific word into a machine learning model generated by machine learning based on a first vector associated with a first word included in the information and a vector corresponding to each of letters included in the first word.

### SUMMARY

According to an aspect of the embodiments, a non-transitory computer-readable storage medium storing a vectorization program that causes at least one computer to execute a process, the process includes: receiving a document; and based on information in which words and vectors are associated with each other, when a certain word that is not included in the information is detected from the document, generating a vector corresponding to the certain word by inputting a vector corresponding to each of letters included in the certain word into a machine learning model generated by machine learning based on a first vector associated with a first word included in the information and a vector corresponding to each of letters included in the first word.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing a process executed by an information processing apparatus;

FIG. 2 is a diagram describing a problem;

FIG. 3 is a diagram describing details of a process executed by an information processing apparatus according to Embodiment 1;

FIG. 4 is a functional block diagram illustrating a functional configuration of an information processing apparatus according to Embodiment 1;

FIG. 5 is a diagram describing a CNN word embedding model;

FIG. 6 is a diagram describing a contextualized word embedding model;

FIG. 7 is a diagram describing a first vector representation result;

FIG. 8 is a diagram describing appearance determination of an unknown word;

FIG. 9 is a diagram describing generation of a trained word embedder model;

FIG. 10 is a diagram describing generation of a vector representation when an unknown word appears;

FIG. 11 is a flowchart illustrating a flow of an overall process;

FIG. 12 is a flowchart illustrating a flow of model generation processing;

FIG. 13 is a diagram describing another example of an unknown word determination; and

FIG. 14 is a diagram illustrating an example of a hardware configuration.

### DESCRIPTION OF EMBODIMENTS

In the above-described technique, since the context interpretation is executed after replacing all unknown words with “_UMK_”, all of the words having actually different meanings are recognized as “_UMK_”, and thus the accuracy of the generated vector representation deteriorates.

When a second machine learning model is applied to a field different from that of the training data, it is also conceivable to recreate a contextualized word embedding model. However, since the contextualized word embedding model depends on “emb” generated by the word embedding model, it is difficult to accurately recreate the contextualized word embedding model in a short time without changing the word embedding model.

In one aspect, an object is to provide a vectorization program, a vectorization method, and an information processing apparatus, which are capable of suppressing the deterioration in accuracy of vector representations of words.

According to one embodiment, it is possible to suppress the deterioration in accuracy of vector representations of words.

Hereinafter, embodiments of a vectorization program, a vectorization method, and an information processing apparatus disclosed in the present application will be described in detail with reference to the drawings. Note that the embodiments do not limit the present disclosure. The embodiments may be combined with each other as appropriate within the scope without contradiction.

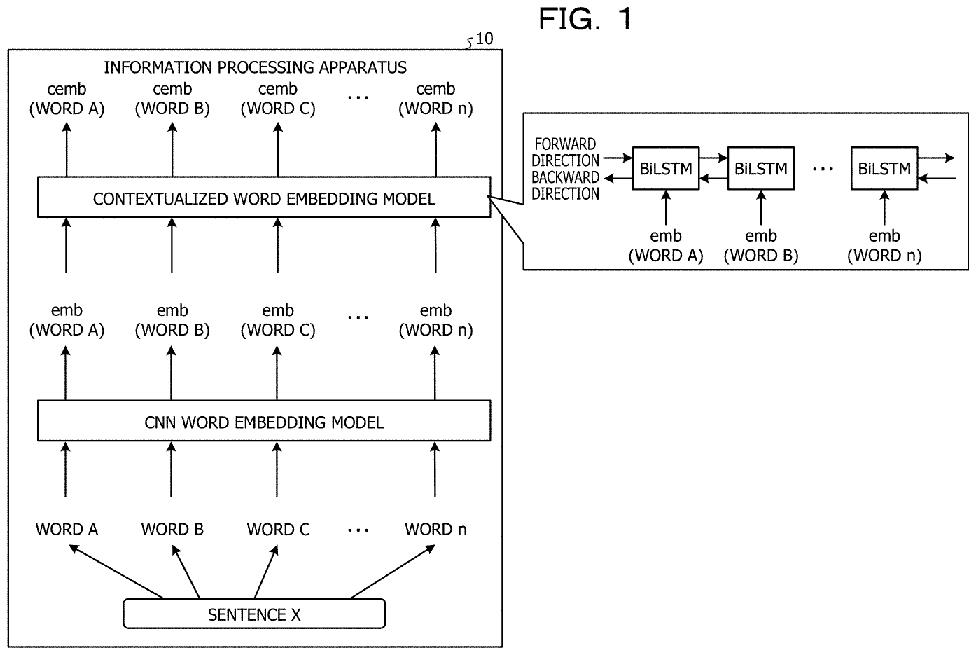

FIG. 1 is a diagram describing a process executed by an information processing apparatus 10. The information processing apparatus 10 illustrated in FIG. 1 is an example of a computer apparatus configured to vectorize words by using a “convolutional neural network (CNN) word embedding model” and a “contextualized word embedding model”. For example, the information processing apparatus 10 generates a vector representation in consideration of context from each word in an inputted document.

The CNN word embedding model is an example of a first machine learning model generated by machine learning using words, and outputs, when a word is input, a vector representation “emb(word)” corresponding to the word.

The contextualized word embedding model is an example of a second machine learning model generated by machine learning using words appearing in a document and the order of appearance of the words, and generates, when a vector representation “emb(word)” of a word is input, a vector representation “cemb(word)” in consideration of context. In the contextualized word embedding model, machine learning is executed by a bidirectional deep learning technique (bidirectional long short-term memory), and a word is bidirectionally recognized from a forward direction and a backward direction, thereby generating a vector representation in consideration of context.

In this configuration, as illustrated in FIG. 1, the information processing apparatus 10 extracts “word A, word B, word C, . . . , word n” from a document X. Subsequently, the information processing apparatus 10 generates a vector representation of each word by using the “CNN word embedding model”. For example, the information processing apparatus 10 generates a vector representation “emb(word A)” for the word A and a vector representation “emb(word B)” for the word B.

Then, the information processing apparatus 10 inputs the vector representation “emb(word)” of each word into the “contextualized word embedding model” in the order of appearance in the document X so as to generate a vector representation “cemb(word)” in consideration of context. For example, the contextualized word embedding model recognizes “emb(word A)”, “emb(word B)”, . . . , and “emb(word n)” from the forward direction and the backward direction, so as to generate “cemb(word A)” for the word A, and output “cemb(word B)” or the like for the word B.

As described above, the information processing apparatus 10 is able to convert an inputted document into vector representations by combining two machine learning models.

In the method of combining two machine learning models, when an unknown word (newly-found word) that is not included in the training data is found during the machine learning of the CNN word embedding model, the unknown word may be replaced with “_UMK_” and processed. However, since context interpretation is executed after replacing all unknown words with “_UMK_”, all of the words having actually different meanings are recognized as “_UMK_”, and the accuracy of the generated embedded representation deteriorates.

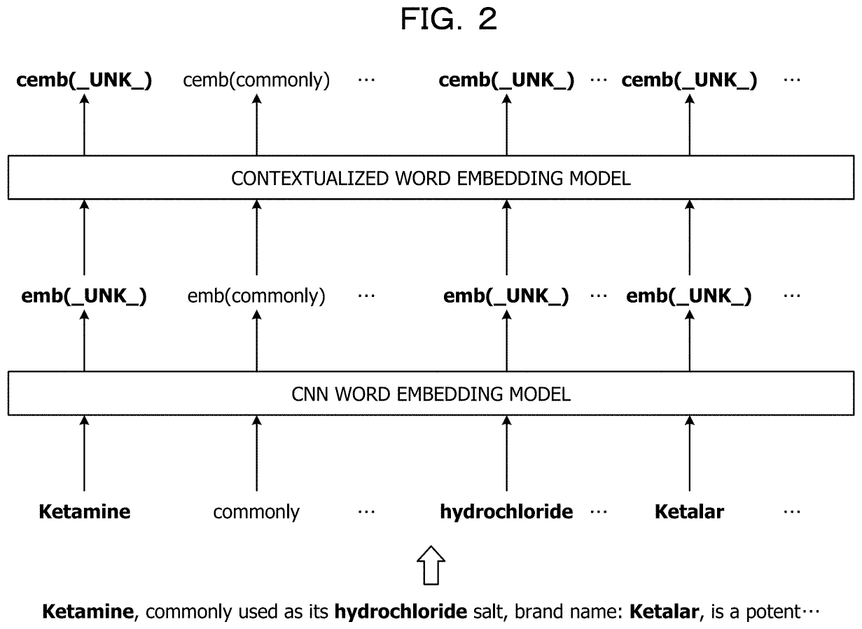

FIG. 2 is a diagram describing a problem. In FIG. 2, an input document “Ketamine, commonly used as its hydrochloride salt, brand name: Ketalar, is a potent . . . ” is exemplified and described. First, the input document is broken down into words such as “Ketamine”, “commonly”, “used”, “as”, and “its”. Among them, “Ketamine”, “hydrochloride”, and “Ketalar” are considered to be unknown words.

Subsequently, a vector representation of each word is generated by using the CNN word embedding model. The vector representation of each of the unknown words “Ketamine”, “hydrochloride”, and “Ketalar” is generated as “emb(_UMK_)”, and the vector representations of other words having been previously found and having experienced machine learning are each generated as “emb(word)” as usual.

After that, each vector representation is input into the contextualized word embedding model to generate a vector representation in consideration of context. As for the previously-found words, “emb(word)” is input and “cemb(word)” is generated, but as for the unknown words, “emb(_UMK_)” is input and “cemb(_UMK_)” is generated.

When an unknown word is included in the document, bidirectional recognition including “emb(_UMK_)” is executed in the contextualized word embedding model, and thus the context of the unknown word may not be taken into consideration and the accuracy in vector representation of the previously-found word deteriorates. For example, in a document in which unknown words are frequently found, the deterioration in accuracy is also noticeable.

Thus, as for unknown words, the information processing apparatus 10 according to Embodiment 1 suppresses the deterioration in vector representation accuracy by generating a new machine learning model of “trained word embedder” while maintaining the CNN word embedding model of the known words.

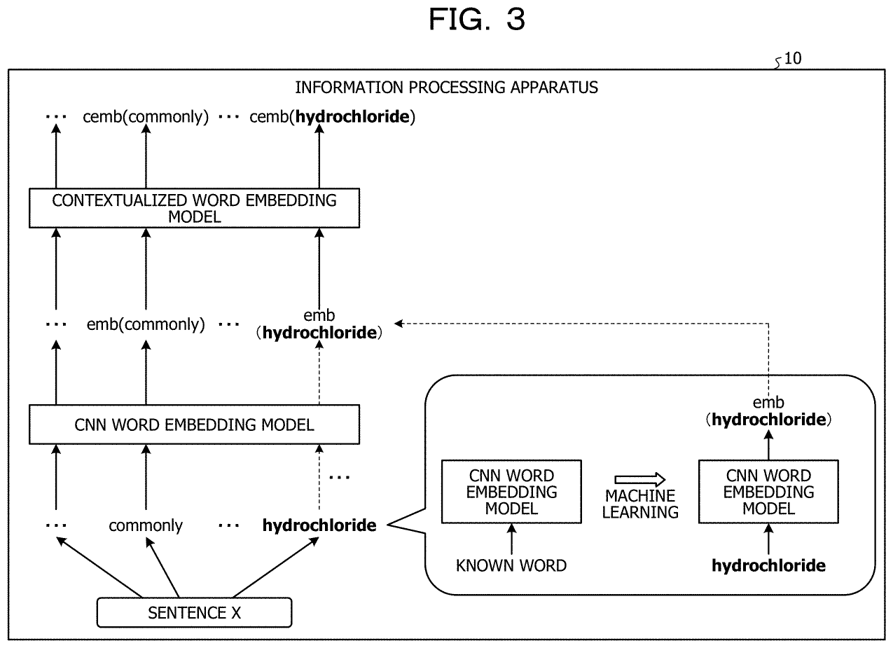

FIG. 3 is a diagram describing details of a process executed by the information processing apparatus 10 according to Embodiment 1. In FIG. 3, the same input document “Ketamine, commonly used as its hydrochloride salt, brand name: Ketalar, is a potent . . . ” as that in FIG. 2 is exemplified and described. As illustrated in FIG. 3, the information processing apparatus 10 generates a new machine learning model of “trained word embedder” for the unknown word “hydrochloride” by taking part of the CNN word embedding model corresponding to the known words as an initial value.

Then, the information processing apparatus 10 generates a vector representation “emb(word)” for the known word by using the CNN word embedding model having experienced machine learning, and generates a vector representation “emb(hydrochloride)” for the unknown word “hydrochloride” by using the newly generated trained word embedder model.

After that, the information processing apparatus 10 inputs each vector representation of the known word and the unknown word into the contextualized word embedding model in the order of appearance, and generates “cemb(known word)” for the known word and “cemb(hydrochloride)” for the unknown word “hydrochloride” as vector representations in consideration of context.

As described above, even when an unknown word is found, the information processing apparatus 10 may generate a new machine learning model for the unknown word by machine learning using the known words and may generate a vector representation corresponding to the unknown word, instead of the vector representation in which unknown words are replaced alike. As a result, the information processing apparatus 10 may suppress the deterioration in vector representation accuracy of the words.

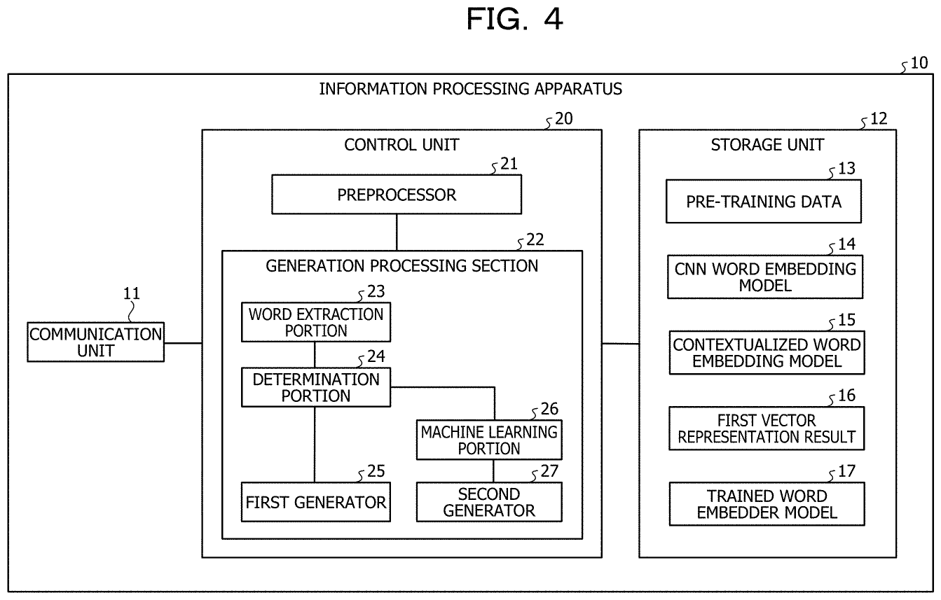

FIG. 4 is a functional block diagram illustrating a functional configuration of the information processing apparatus 10 according to Embodiment 1. As illustrated in FIG. 4, the information processing apparatus 10 includes a communication unit 11, a storage unit 12, and a control unit 20.

The communication unit 11 controls communications with other apparatuses. For example, the communication unit 11 receives, from an administrator terminal (not illustrated) or the like, a document from which vector representations are to be generated, and receives an instruction to start processing for generating vector representations or the like.

The storage unit 12 stores various data, various programs to be executed by the control unit 20, and so forth. For example, the storage unit 12 stores pre-training data 13, a CNN word embedding model 14, a contextualized word embedding model 15, a first vector representation result 16, and a trained word embedder model 17.

The pre-training data 13 is training data used for machine learning of the CNN word embedding model 14, the contextualized word embedding model 15, and the like, and includes a plurality of pieces of document data. For example, the pre-training data 13 may be document data of the same field or document data of different fields.

The CNN word embedding model 14 is a machine learning model generated by machine learning performed by a preprocessor 21 described later. For example, in response to input of a word, the CNN word embedding model 14 outputs a vector representation in which the word is represented by a vector.

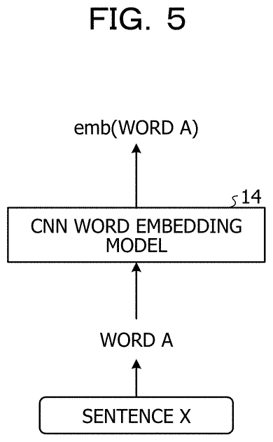

FIG. 5 is a diagram describing the CNN word embedding model 14. As illustrated in FIG. 5, when a word A in the document X is input, the CNN word embedding model 14 breaks down the word A into letter units and vectorizes each letter by using a technique such as one-hot encoding. For example, the letter “a” is expressed as [1.0.0.0.0], and the letter “b” is expressed as [0.0.1.0.0]. The CNN word embedding model 14 generates a vector representation “emb(word A)” of the word A by combining the vectors of the respective letters.

The contextualized word embedding model 15 is a machine learning model generated by machine learning performed by the preprocessor 21 described later. For example, in response to input of a plurality of words, the contextualized word embedding model 15 outputs a vector representation of each word while taking into consideration the order of appearance of the words.

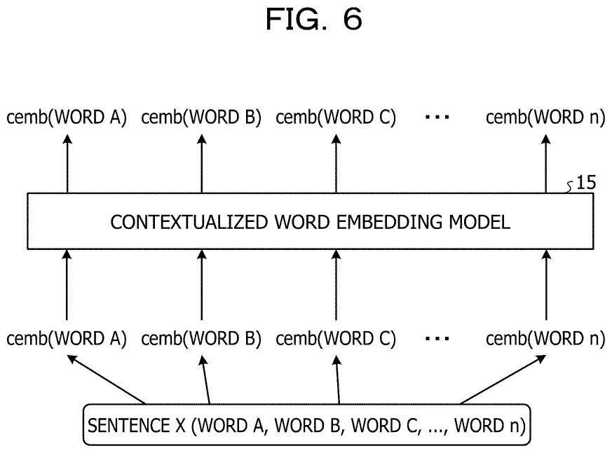

FIG. 6 is a diagram describing the contextualized word embedding model 15. As illustrated in FIG. 6, when vector representations “emb(word A), emb(word B), emb(word C), . . . , emb(word n)” of the words (word A, word B, word C, . . . , and word n) included in the document X are input from the beginning in the order of appearance, the contextualized word embedding model 15 executes bidirectional recognition and outputs vector representations “cemb(word A), cemb(word B), cemb(word C), . . . , cemb(word n)” in consideration of context.

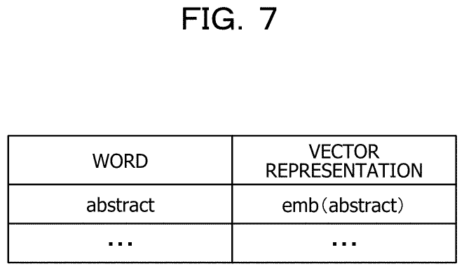

The first vector representation result 16 is information generated by the CNN word embedding model 14, in which words are associated with vectors. For example, the first vector representation result 16 is information generated by using the CNN word embedding model 14 having experienced machine learning. FIG. 7 is a diagram describing the first vector representation result 16. As illustrated in FIG. 7, the first vector representation result 16 is information in which “words and vector representations” are associated with each other. “Word” is a word to be vectorized, and “vector representation” is a vector generated by the CNN word embedding model 14. An example in FIG. 7 indicates that a vector representation “emb(abstract)” is generated for the word “abstract”.

The trained word embedder model 17 is a machine learning model generated by the control unit 20 described later. For example, the trained word embedder model 17 is a machine learning model for generating a vector representation of an unknown word when the unknown word is found. For example, when 10 unknown words are found, 10 trained word embedder models 17 are generated.

The control unit 20 is a processing unit that manages the overall information processing apparatus 10 and includes the preprocessor 21 and a generation processing section 22.

The preprocessor 21 generates the CNN word embedding model 14 and the contextualized word embedding model 15 by machine learning using the pre-training data 13. As a machine learning method, various machine learning approaches used in vectorization techniques of the natural language processing may be employed.

For example, the preprocessor 21 selects the document X in the pre-training data 13 and breaks down the document X into words by using morphological analysis or the like. The preprocessor 21 selects each word one by one and breaks down the word into letter units. After that, the preprocessor 21 vectorizes each letter by using a technique such as one-hot encoding, inputs the vectorized letter into the CNN word embedding model 14, and executes machine learning to predict a vector representation of the word.

Then, the preprocessor 21 generates a vector representation of each word used in the machine learning by using the CNN word embedding model 14 having experienced the machine learning, and stores the generated vector representation in the first vector representation result 16. The preprocessor 21 may acquire a vector representation of each word at the time of machine learning of the CNN word embedding model 14, and store the acquired vector representation in the first vector representation result 16.

When the machine learning of the CNN word embedding model 14 is completed, the preprocessor 21 executes machine learning of the contextualized word embedding model 15. For example, the preprocessor 21 acquires, from the first vector representation result 16, the vector representation “emb(word)” of each word included in the document X. Subsequently, the preprocessor 21 inputs the vector representation “emb(word)” of each word into the contextualized word embedding model 15 in the order of appearance in the document X, and executes machine learning to predict a vector representation of the word in consideration of context.

The generation processing section 22 includes a word extraction portion 23, a determination portion 24, a first generator 25, a machine learning portion 26, and a second generator 27, and generates a vector representation of a sentence to be processed by using the CNN word embedding model 14 and the contextualized word embedding model 15 generated by the preprocessor 21.

The word extraction portion 23 extracts words from a sentence to be processed for vector representations. For example, the word extraction portion 23 performs morphological analysis or the like on a document Y to be processed, breaks down the document Y into words “. . . , word B, act, . . . , word n”, and outputs the words to the determination portion 24.

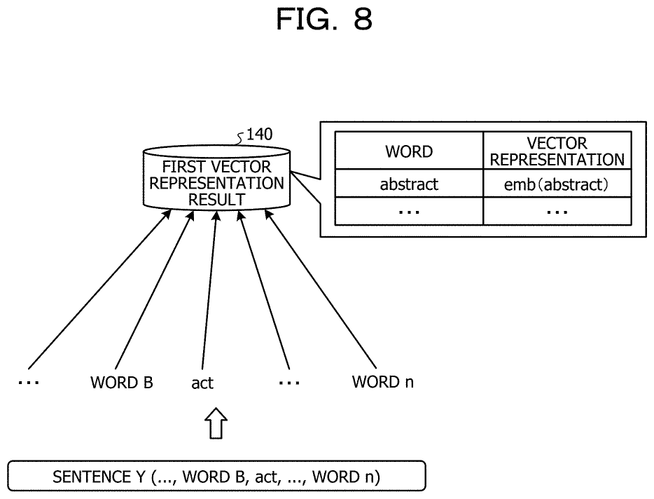

The determination portion 24 determines whether each of the words extracted by the word extraction portion 23 is an unknown word that is not included in the pre-training data 13. FIG. 8 is a diagram describing appearance determination of an unknown word. As illustrated in FIG. 8, the determination portion 24 refers to the first vector representation result 16 and determines whether the extracted words “. . . , word B, act, . . . , word n” are registered in the first vector representation result 16. The determination portion 24 determines a word (for example, act) that is not registered in the first vector representation result 16 as an unknown word.

When no unknown word has been detected, the determination portion 24 outputs each word extracted by the word extraction portion 23 to the first generator 25. On the other hand, when an unknown word has been detected, the determination portion 24 outputs the unknown word to the machine learning portion 26 and outputs each word extracted by the word extraction portion 23 to the second generator 27.

The first generator 25 generates a vector representation of a document including no unknown word. For example, the first generator 25 acquires, from the first vector representation result 16, the vector representation “emb(word)” of each word in the document input from the determination portion 24. The first generator 25 inputs the vector representation “emb(word)” of each word into the contextualized word embedding model 15 in the order of appearance of the words so as to acquire a vector representation “cemb(word)” of each word. The first generator 25 stores a generation result in which the document, words, and vector representations are associated with each other in the storage unit 12, displays the generation result on a display or the like, transmits the generation result to the administrator terminal, or the like.

The machine learning portion 26 generates the trained word embedder model 17 corresponding to the unknown word. For example, the machine learning portion 26 generates the trained word embedder model 17 by machine learning based on a first vector associated with a first word and a vector corresponding to each letter included in the first word, which are registered in the first vector representation result 16.

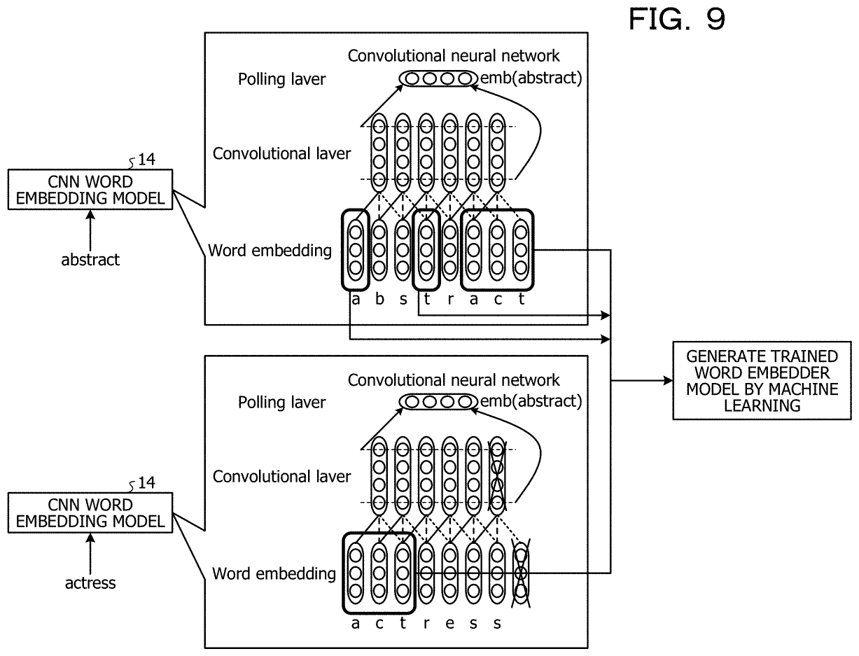

FIG. 9 is a diagram describing the generation of the trained word embedder model 17. The unknown word “act” is taken as an example in the description below. As illustrated in FIG. 9, the CNN word embedding model 14 includes an input layer (word embedding layer), a convolutional layer, and a pooling layer. The trained word embedder model 17 is generated by machine learning while taking the input layer (word embedding layer) of the CNN word embedding model 14 as an initial value.

For example, the machine learning portion 26 identifies “abstract”, “actress”, and the like as known words registered in the first vector representation result 16 including any of the letters “a”, “c”, and “t” of the unknown word “act”. Subsequently, the machine learning portion 26 performs morphological analysis on the known word “abstract” to break it down into the letters “a”, “b”, “s”, “t”, “r”, “a”, “c”, and “t”. The machine learning portion 26 identifies the letters “a”, “t”, “a”, “c”, and “t”, among the letters “a”, “b”, “s”, “t”, “r”, “a”, “c”, and “t” of the known word “abstract”, that match the letters of the unknown word.

Thereafter, the machine learning portion 26 acquires, from the CNN word embedding model 14, each word embedding (vector representation) of “a”, “t”, “a”, “c”, and “t” when the known word “abstract” was input to the CNN word embedding model 14. Then, the machine learning portion 26 executes machine learning of the trained word embedder model 17 by taking each of the acquired word embedding of “a”, “t”, “a”, “c”, and “t” as an initial value. For example, the machine learning portion 26 performs machine learning of the trained word embedder model 17 in such a manner that the vector representation “emb(abstract)” of the known word “abstract” is not changed.

Similarly, the machine learning portion 26 performs morphological analysis on the known word “actress” to break it down into the letters “a”, “c”, “t”, “r”, “e”, “s”, and “s”. The machine learning portion 26 identifies “a”, “c”, and “t”, among the letters “a”, “c”, “t”, “r”, “e”, “s”, and “s” of the known word “actress”, that match the letters of the unknown word.

Thereafter, the machine learning portion 26 acquires, from the CNN word embedding model 14, each word embedding of “a”, “c”, and “t” when the known word “actress” was input to the CNN word embedding model 14. Then, the machine learning portion 26 executes machine learning of the trained word embedder model 17 while inputting each of the acquired word embedding of “a”, “c”, and “t” thereto. For example, the machine learning portion 26 performs machine learning of the trained word embedder model 17 in such a manner that the vector representation “emb(actress)” of the known word “actress” is not changed.

In this manner, when the machine learning of the trained word embedder model 17 for the unknown word “act” is completed, the machine learning portion 26 vectorizes the letters “a”, “c”, and “t” by using a technique such as one-hot encoding, and inputs the vectorized letters into the trained word embedder model 17. Subsequently, the machine learning portion 26 acquires output of the trained word embedder model 17 as a vector representation “emb(act)” of the unknown word “act”.

The machine learning portion 26 stores the unknown word “act” and the vector representation “emb(act)” in the storage unit 12 in a state of being associated with each other, and outputs them to the second generator 27. The machine learning portion 26 may store the association between the unknown word “act” and the vector representation “emb(act)” acquired by using the trained word embedder model 17 in the first vector representation result 16.

As described above, the machine learning portion 26 performs machine learning of the trained word embedder model 17 by using the word embedding of the known word including letters of the unknown word. As a result, the machine learning portion 26 may generate the vector representation of the unknown word without changing the CNN word embedding model 14 having experienced machine learning. The trained word embedder model 17 may employ the same form of machine learning model and the same machine learning technique as those of the CNN word embedding model 14.

The second generator 27 generates a vector representation of a document including unknown words. For example, the second generator 27 acquires a vector representation regarding a known word from the first vector representation result 16, acquires a vector representation regarding an unknown word from the machine learning portion 26, inputs these acquired vector representations into the contextualized word embedding model 15 in the order of appearance in the document, and acquires a vector representation “cemb(word)” of each word.

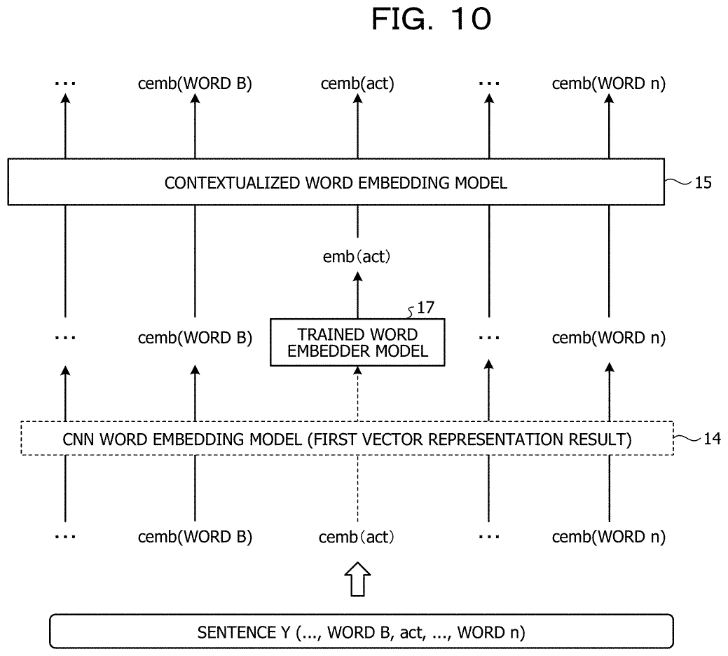

FIG. 10 is a diagram describing the generation of a vector representation when an unknown word appears. As illustrated in FIG. 10, the second generator 27 acquires a vector representation “emb(word B)” or the like from the first vector representation result 16 for the word B or the like other than the unknown word “act”, among the words “. . . , word B, act, . . . , word n” extracted from the document Y. On the other hand, as for the unknown word “act”, the second generator 27 acquires the vector representation “emb(act)” generated by the trained word embedder model 17.

The second generator 27 inputs the vector representation “emb(word)” of each word into the contextualized word embedding model 15 in the order of appearance in the document Y so as to acquire a vector representation “cemb(word)” of each word. The second generator 27 stores a generation result in which the document Y, words, and vector representations are associated with each other in the storage unit 12, displays the generation result on a display or the like, transmits the generation result to the administrator terminal, or the like.

Thus, even when an unknown word appears, a vector representation may be generated without replacing the unknown word with “UMK”.

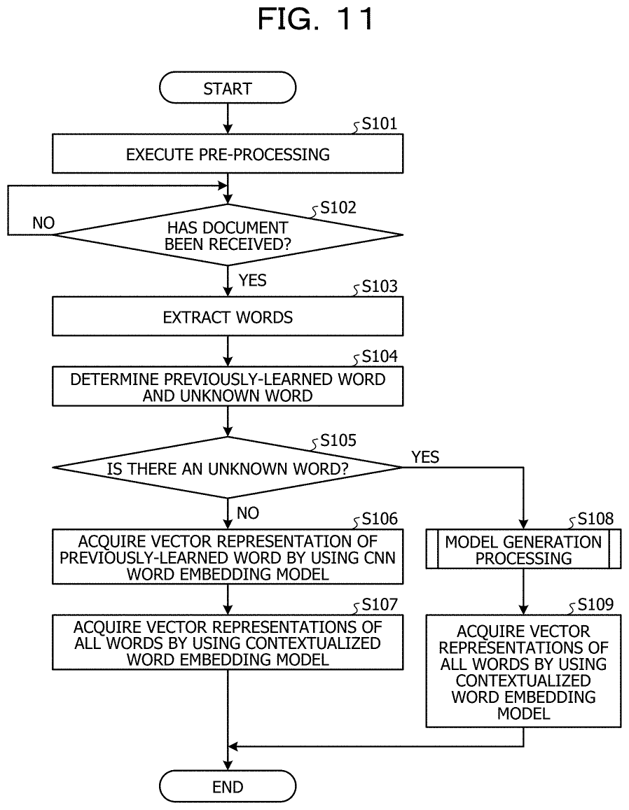

Next, a flow of the above-described process will be described. FIG. 11 is a flowchart illustrating a flow of the overall process. As illustrated in FIG. 11, the preprocessor 21 executes pre-processing to generate the CNN word embedding model 14 and the contextualized word embedding model 15 by machine learning using the pre-training data 13 (S101).

Subsequently, when the word extraction portion 23 receives a document to be processed (S102: Yes), the word extraction portion 23 extracts words from the document (S103). Then, the determination portion 24 refers to the first vector representation result 16 and determines whether each of the words corresponds to any of a previously-learned word (known word) or an unknown word (newly-found word) (S104).

When there is no unknown word (S105: No), the first generator 25 uses the CNN word embedding model 14 to acquire a vector representation of the previously-learned word (S106). Then, the first generator 25 acquires vector representations of all words by using the contextualized word embedding model 15 (S107).

On the other hand, when an unknown word exists (S105: Yes), the machine learning portion 26 executes model generation processing (S108), and thereafter the second generator 27 uses the contextualized word embedding model 15 to acquire vector representations of all words (S109).

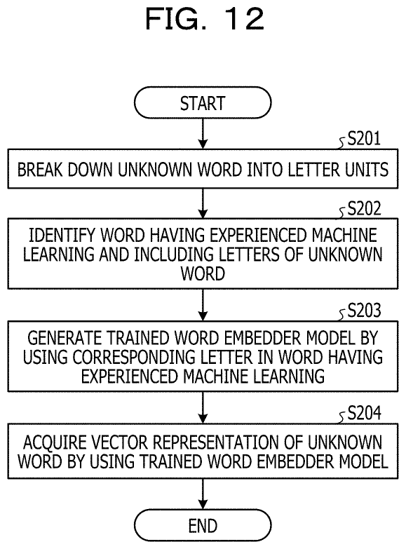

Next, the model generation processing executed in S108 will be described. FIG. 12 is a flowchart illustrating a flow of the model generation processing. As illustrated in FIG. 12, the machine learning portion 26 breaks down the unknown word into letter units (S201), and identifies a word (known word) having experienced machine learning and including letters of the unknown word (S202).

Then, the machine learning portion 26 generates the trained word embedder model 17 by using the corresponding letter in the word (known word) having experienced machine learning (S203). Thereafter, the machine learning portion 26 uses the trained word embedder model 17 to acquire a vector representation of the unknown word (S204).

As described above, even when an unknown word not included in the pre-training dataset 13 is found, the information processing apparatus 10 is able to generate a vector representation without replacing the unknown word with “_UMK_”, and thus the apparatus is able to input the vector representation of each word into the contextualized word embedding model 15. As a result, the contextualized word embedding model 15 is able to generate vector representations in consideration of the vector representations of words in a document and the order of appearance of the words, which makes it possible to suppress the deterioration in vector representation accuracy of the words.

Even when an unknown word is found, the information processing apparatus 10 does not have to execute again the machine learning of the CNN word embedding model 14, the contextualized word embedding model 15, and the like, which makes it possible to shorten the time requested for generating vector representations. The information processing apparatus 10 may be easily applied to fields different from the field of the training data used in the machine learning.

While embodiments of the present disclosure have been described, the present disclosure may be implemented in various different forms other than the above-described embodiments.

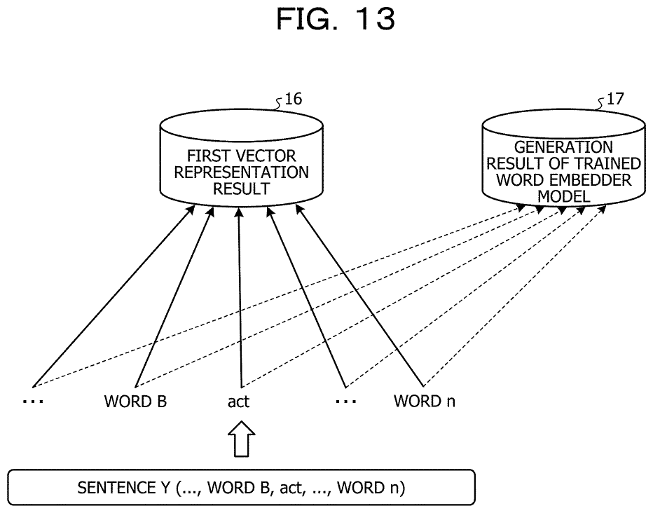

For example, at the time of determining an unknown word, the determination portion 24 may make the determination by referring to not only the first vector representation result 16 but also the trained word embedder model 17 generated every time an unknown word appears. FIG. 13 is a diagram describing another example of an unknown word determination. As illustrated in FIG. 13, the determination portion 24 determines whether each of the words included in the document Y is included in any of the first vector representation result 16 and the trained word embedder model 17, and determines a word not included in any of them as an unknown word.

In the examples described above, English words are used. However, the present disclosure is not limited thereto, and the same processing may be performed on other languages. For example, in a case of Japanese, a kanji word pronounced “ko dou” is broken down into two kanji characters pronounced “ko” and “dou”, respectively, and processed.

The document data, words, examples of letter configurations, and the like used in the above-described embodiments are merely examples and may be optionally changed.

Unless otherwise specified, processing procedures, control procedures, specific names, and information including various kinds of data and parameters described in the above-described document or drawings may be optionally changed.

Each element of each illustrated apparatus is of a functional concept, and may not be physically constituted as illustrated in the drawings. For example, the specific form of distribution or integration of each apparatus is not limited to that illustrated in the drawings. For example, the entirety or part of the apparatus may be constituted so as to be functionally or physically distributed or integrated in any units in accordance with various kinds of loads, usage states, or the like.

All or any part of the processing functions performed by each apparatus may be achieved by a central processing unit (CPU) and a program analyzed and executed by the CPU or may be achieved by a hardware apparatus using wired logic.

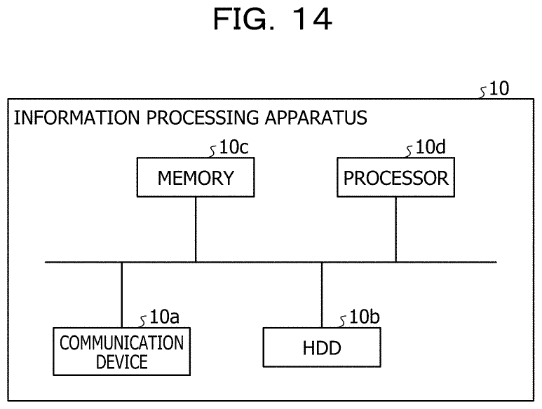

FIG. 14 is a diagram illustrating an example of a hardware configuration. As illustrated in FIG. 14, the information processing apparatus 10 includes a communication device 10a, a hard disk drive (HDD) 10b, a memory 10c, and a processor 10d. The components illustrated in FIG. 14 are coupled to one another by a bus or the like.

The communication device 10a is a network interface card or the like and communicates with other apparatuses. The HDD 10b stores programs for causing the functions illustrated in FIG. 4 to operate, a database (DB), and the like.

The processor 10d reads, from the HDD 10b or the like, programs that perform processing similar to the processing performed by the processing units illustrated in FIG. 4 and loads the read programs on the memory 10c, whereby a process that performs the functions described in FIG. 4 or the like is operated. For example, this process executes the functions similar to the functions of the processing units included in the information processing apparatus 10. For example, the processor 10d reads, from the HDD 10b or the like, a program that implements the same functions as those of the preprocessor 21, the generation processing section 22, and the like. Then, the processor 10d executes the process that performs the same processing as that of the preprocessor 21, the generation processing section 22, and the like.

As described above, the information processing apparatus 10 operates as an information processing apparatus configured to carry out a vector generation method by reading out and executing programs. The information processing apparatus 10 may also achieve the functions similar to the functions of the above-described embodiments by reading out the above-described programs from a recording medium with a medium reading device and executing the above-described read programs. The programs described in another embodiment are not limited to the programs to be executed by the information processing apparatus 10. For example, the present disclosure may be similarly applied to when another computer or server executes the programs or when another computer and server execute the programs in cooperation with each other.

The programs may be distributed via a network such as the Internet. The programs may be recorded on a computer-readable recording medium such as a hard disk, a flexible disk (FD), a compact disc read-only memory (CD-ROM), a magneto-optical disk (MO), or a Digital Versatile Disc (DVD), and may be executed by being read out from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a vectorization program that causes at least one computer to execute a process, the process comprising:
receiving a document; and
based on information in which words and vectors are associated with each other, when a certain word that is not included in the information is detected from the document, generating a vector corresponding to the certain word by inputting a vector corresponding to each of letters included in the certain word into a machine learning model generated by machine learning based on a first vector associated with a first word included in the information and a vector corresponding to each of letters included in the first word.

2. The non-transitory computer-readable storage medium according to claim 1, the process further comprising:
extracting words from each of a plurality of the documents,
generating a first machine learning model by machine learning using the extracted words, and
generating the information by using the first machine learning model.

3. The non-transitory computer-readable storage medium according to claim 1, wherein
the generating the vector includes,
extracting a plurality of the words from the received document in order of appearance of the words,
for previously-found words other than the certain word among the plurality of words, generating the vectors corresponding to the previously-found words based on the information,
for the certain word among the plurality of words, generating the vector corresponding to the certain word by using the machine learning model, and
generating a vector corresponding to each of the plurality of words in the document by inputting the vector of each of the plurality of words in the order of appearance in the document into a second machine learning model generated by machine learning using a bidirectional deep learning technique for performing bidirectional recognition in the order of appearance of the words and in the order reverse to the order of appearance of the words.

4. The non-transitory computer-readable storage medium according to claim 1, the process further comprising:
dividing the received document into words,
determining whether each of the divided words is registered in the information, or whether the machine learning model corresponding to each of the words exists, and
determining, as the certain word, the word that is not registered in the information and corresponding to which the machine learning model does not exist.

5. A vectorization method for a computer to execute a process comprising:
receiving a document, and
based on information in which words and vectors are associated with each other, when a certain word that is not included in the information is detected from the document, generating a vector corresponding to the certain word by inputting a vector corresponding to each of letters included in the certain word into a machine learning model generated by machine learning based on a first vector associated with a first word included in the information and a vector corresponding to each of letters included in the first word.

6. The vectorization method according to claim 5, the process further comprising:
extracting words from each of a plurality of the documents,
generating a first machine learning model by machine learning using the extracted words, and
generating the information by using the first machine learning model.

7. The vectorization method according to claim 5, wherein
the generating the vector includes:
extracting a plurality of the words from the received document in order of appearance of the words,
for previously-found words other than the certain word among the plurality of words, generating the vectors corresponding to the previously-found words based on the information,
for the certain word among the plurality of words, generating the vector corresponding to the certain word by using the machine learning model, and
generating a vector corresponding to each of the plurality of words in the document by inputting the vector of each of the plurality of words in the order of appearance in the document into a second machine learning model generated by machine learning using a bidirectional deep learning technique for performing bidirectional recognition in the order of appearance of the words and in the order reverse to the order of appearance of the words.

8. The vectorization method according to claim 5, the process further comprising:
dividing the received document into words,
determining whether each of the divided words is registered in the information, or whether the machine learning model corresponding to each of the words exists, and
determining, as the certain word, the word that is not registered in the information and corresponding to which the machine learning model does not exist.

9. An information processing apparatus comprising:
one or more memories; and
one or more processors coupled to the one or more memories and the one or more processors configured to:
receive a document, and
based on information in which words and vectors are associated with each other, when a certain word that is not included in the information is detected from the document, generate a vector corresponding to the certain word by inputting a vector corresponding to each of letters included in the certain word into a machine learning model generated by machine learning based on a first vector associated with a first word included in the information and a vector corresponding to each of letters included in the first word.

10. The vectorization method according to claim 9, wherein the one or more processors further configured to:
extract words from each of a plurality of the documents,
generate a first machine learning model by machine learning using the extracted words, and
generate the information by using the first machine learning model.

11. The vectorization method according to claim 9, wherein the one or more processors further configured to:
extract a plurality of the words from the received document in order of appearance of the words,
for previously-found words other than the certain word among the plurality of words, generate the vectors corresponding to the previously-found words based on the information,
for the certain word among the plurality of words, generate the vector corresponding to the certain word by using the machine learning model, and
generate a vector corresponding to each of the plurality of words in the document by inputting the vector of each of the plurality of words in the order of appearance in the document into a second machine learning model generated by machine learning using a bidirectional deep learning technique for performing bidirectional recognition in the order of appearance of the words and in the order reverse to the order of appearance of the words.

12. The vectorization method according to claim 9, wherein the one or more processors further configured to:
divide the received document into words,
determine whether each of the divided words is registered in the information, or whether the machine learning model corresponding to each of the words exists, and
determine, as the certain word, the word that is not registered in the information and corresponding to which the machine learning model does not exist.
